(19) United States
(12) Patent Application Publication
(10) Pub. No.: US 2025/0109984 A1
(43) Pub. Date: Apr. 3, 2025

(54) APPARATUS AND METHODS FOR ESTIMATING SOLAR RADIATION ENERGY RESOURCES WITH CONTINUOUS CALIBRATION

(71) Applicant: BrightNight Power LLC, West Palm Beach, FL (US)

(72) Inventors: Ben BOURNE, Davis, CA (US); Chetan CHAUDHARI, Leander, TX (US); Lucas HARVEY, Orinda, CA (US)

(73) Assignee: BrightNight Power LLC, West Palm Beach, FL (US)

(21) Appl. No.: 18/897,270

(22) Filed: Sep. 26, 2024

Related U.S. Application Data
(60) Provisional application No. 63/586,481, filed on Sep. 29, 2023.

(51) Int. Cl. G01J 1/42; G01W 1/12

(52) U.S. Cl. CPC G01J 1/42; G01W 1/12; G01J 2001/4266

(57) ABSTRACT

Apparatus, methods, and non-transitory computer readable medium for estimating solar radiation energy resources. The method includes receiving a request for estimating solar radiation energy resources for a solar site; obtaining metadata about the solar site; obtaining satellite weather data corresponding to the solar site; obtaining measured solar data on the solar site; generating a training dataset based on the satellite weather data and the measured solar data; training a machine learning model by the training dataset; and synthesizing solar radiation energy resource data corresponding to the solar site using the machine learning model.

### CROSS-REFERENCE TO RELATED APPLICATIONS

This application claims the benefit of priority to U.S. Provisional Patent Application No. 63/586,481, filed on Sep. 29, 2023, the entire contents of which are incorporated herein by reference.

### BACKGROUND

It may be desirable to estimate solar radiation energy resources of a solar site. For example, a solar energy company may wish to estimate the solar radiation energy resources of the solar site during a specific period.

### SUMMARY

Consistent with embodiments of the present disclosure, there is provided a non-transitory computer-readable medium storing instructions that are executable by one or more processors of a device to perform operations for estimating solar radiation energy resources. The operations include obtaining metadata about a solar site, obtaining satellite weather data corresponding to the solar site, obtaining measured solar data on the solar site, generating a training dataset based on the satellite weather data and the measured solar data, training a machine learning model by the training dataset, and synthesizing solar radiation energy resource data corresponding to the solar site using the machine learning model.

Also, consistent with embodiments of the present disclosure, there is provided an apparatus for estimating solar radiation energy resources. The apparatus includes a memory storing instructions and at least one processor configured to execute the instructions to cause the apparatus to: obtain metadata about a solar site, obtain satellite weather data corresponding to the solar site, obtain measured solar data on the solar site, generate a training dataset based on the satellite weather data and the measured solar data, train a machine learning model by the training dataset, and synthesize solar radiation energy resource data corresponding to the solar site using the machine learning model.

In addition, consistent with embodiments of the present disclosure, there is provided a method for estimating solar radiation energy resources. The method includes obtaining metadata about a solar site, obtaining satellite weather data corresponding to the solar site, obtaining measured solar data on the solar site, generating a training dataset based on the satellite weather data and the measured solar data, training a machine learning model by the training dataset, and synthesizing solar radiation energy resource data corresponding to the solar site using the machine learning model.

The above and other aspects and their implementations are described in greater detail in the drawings, the descriptions, and the claims.

### BRIEF DESCRIPTION OF THE DRAWINGS

FIG. 1 is a block diagram of an apparatus for estimating solar radiation energy resources, according to some embodiments of the present disclosure.

FIG. 2 is a flowchart of an exemplary method for estimating solar radiation energy resources, according to some embodiments of the present disclosure.

FIG. 3 is a diagram of an exemplary data flow for estimating solar radiation energy resources, according to some embodiments of the present disclosure.

FIG. 4 illustrates results of an exemplary method for estimating solar radiation energy resources, according to some embodiments of the present disclosure.

FIG. 5 illustrates results of three exemplary methods for estimating solar radiation energy resources, according to some embodiments of the present disclosure.

FIG. 6 illustrates an exemplary solar site control server, according to some embodiments of the present disclosure.

### DETAILED DESCRIPTION

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses, systems, and methods consistent with aspects related to subject matter that may be recited in the appended claims.

Recently, there is great interest in exploiting renewable energy to generate electricity. One renewable energy resource is solar radiation. Photovoltaic (PV) cells are one means used to generate electricity from the solar radiation. A project to construct and operate a facility to generate electricity from solar radiation using photovoltaic cells entails many considerations. More particularly, in such a solar radiation energy resource project, project developers, financiers, and/or implementors need accurate data about available solar radiation energy resources at a proposed solar photovoltaic system location over a specific period, e.g., a particular year or the system's entire lifecycle, to ensure energy generation potential of the system. In some projects, data characterizing solar radiation energy resource may be used to guide site selection during a feasibility study, predict solar photovoltaic power plant output for renewable power plant design and financing, and/or enable post-commissioning plant operations dispatch, diagnostics, and/or electrical power grid services. Depending on the accuracy of solar forecasts in climate zones and micro-climates, actual available solar radiation energy resources at a geographical location may be higher or lower than estimated resources based on satellite weather data. This difference between the estimated and actually measured solar radiation energy resources directly influences project economics. If the actual solar radiation energy resources are greater than the estimated resources, it is possible that not all of the solar energy and its value are captured. If the actual solar radiation energy resources are lower than the estimated resources, that project may underperform. For example, a constructed solar power plant may be too large or too small relative to the actual available solar radiation, resulting in inefficiency in plant operation and/or poor use of land resources. Significant capital investment in land and PV hardware may not be efficiently used because the solar power plant is too large or too small.

Some projects may rely on satellite weather data from multiple vendors to improve the accuracy of solar radiation energy resource estimation. The satellite weather data of different vendors is proxy measurement data because the satellite weather data are obtained by remote sensing from a plurality of satellites, including calculations based on data sensed and/or captured at the plurality of satellites and given weather models and not based on measurement data obtained directly from the solar project site. Combining multiple vendors' proxy measurement data may not improve the accuracy of the solar radiation energy resource estimation because of the lack of actual solar data. In some projects, developers may gather measured solar data for, e.g., one or two months, download satellite weather data from one or more vendors for the same period of time, compile the measured solar data and the satellite weather data, send the compiled data to an analytic service provider to analyze and produce a solar energy analysis report including suggested correcting values to be applied to the satellite weather data. This process may require a certain amount of time and service fees for the vendors of the satellite weather data and the analytic service provider. When different periods of time and/or different numbers of solar sites need to be estimated, it may be necessary to repeat the above process. This process may be usually performed before building a solar site.

In another aspect, after the solar site is built, photovoltaic cells may start to gather solar radiation energy. If there is a need to estimate available solar radiation energy thereafter, the solar energy analysis report, produced before building the solar site, might still be used as reference to estimate the solar radiation energy. The data about the gathered solar radiation energy by the solar site may not be utilized to estimate the solar radiation energy unless another solar energy analysis process as described above is performed. The estimated available solar radiation energy after the solar site is built may be used for solar energy dispatch decisions, which may be time sensitive. The solar energy analysis process described above may not be able to provide a report timely for the energy dispatch decision. In tight margins of today's renewable power plants, it may mean sub-optimal dispatch decisions, which may risk project returns early in the lifetime of the project.

In the present disclosure, the apparatus for estimating solar radiation energy resources may be configured to generate a training dataset, including proxy measurement and solar data and physically measured solar data. The proxy measurement solar data may include solar irradiance estimate data of a solar site and satellite weather data. The apparatus may be configured to calculate the solar irradiance estimate data based on position and geographical information about the solar site. The apparatus may also be configured to request and obtain satellite weather data from one or more vendors. The apparatus may also be configured to periodically request and receive the measured solar data of the solar site. The measured solar data are gathered by sensors, e.g., pyranometers and/or solar radiation sensors or meters, at the solar site for which feasibility is being determined. That is, in the training dataset, the measured solar data are true ground data (e.g., solar radiation for evapotranspiration (ET) and one or more of temperature, humidity, sun, and wind indexes), while the solar irradiance estimate data and satellite weather data are proxy measurements representing the same time period. The measured solar data may include, for example, measured irradiance values and ambient temperatures at the solar site over a time series. The time series may be a series of time points on which there are data, such as the measured irradiance values and ambient temperatures. The series of time points may be with one of a variety of granularity, including one minute, five minutes, ten minutes, fifteen minutes, thirty minutes, one hour, or even a longer time interval. The solar irradiance estimate data may include, for example, clear sky irradiance values over the time series. The satellite weather data may include, for example, satellite irradiance values and ambient temperatures over the time series.

The apparatus may be configured to train a machine learning model using a training dataset that includes both proxy measurement solar data and coincident true ground solar data. Differences between the true ground solar data and the proxy measurement solar data in the training dataset are the corrections required for obtaining accurate solar radiation energy resource data over the time series. The machine learning model may be trained to estimate solar radiation energy resource data based on proxy measurement solar data. After the training, the apparatus may be configured to estimate solar radiation energy resource data for a period in the future based on proxy measurement solar data.

After the measured solar data is used to train the apparatus, the sensors at the solar site may continue to measure additional solar data. The apparatus may be further configured to request and receive the additional measured solar data of the solar site. The apparatus may also be configured to request, obtain, and/or calculate solar irradiance estimate data and satellite weather data corresponding to a time period of the additional measured solar data. The apparatus may be further configured to generate an updated training dataset and train the machine learning model with the updated training dataset. The apparatus may be configured to train the machine learning model continuously whenever the sensors measure an additional amount of solar data. The additional amount of measured solar data for generating an updated timing dataset and re-training the machine learning model may be over one day, one week, one month, two months, or a shorter or longer time period. In some embodiments, the apparatus may train the machine learning model at least before the apparatus may be configured to estimate solar radiation energy resource data.

As compared to traditional solar radiation energy resource estimation which requires months or even years to gather and process data, the apparatus with the continuously trained machine learning model disclosed herein is able to estimate solar radiation energy resource data in minutes or hours. This may help solar project developers, financiers, and/or implementors to design and/or implement a solar project efficiently. Moreover, the apparatus with the continuously trained machine learning model is able to estimate solar radiation energy resource data for any length of time. This flexibility may allow solar project developers, financiers, and/or implementors to evaluate a plurality of project lengths without spending too much time on data analysis. After a solar site is built and operational, the apparatus with the continuously trained machine learning model may also be used to estimate solar radiation energy resource data on an ongoing basis for energy dispatch or arrangement.

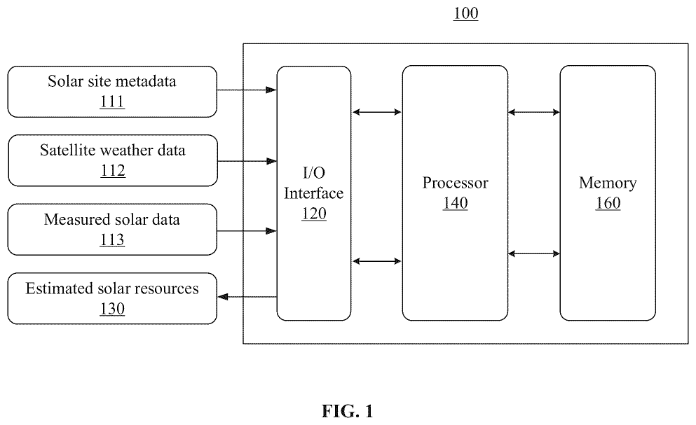

FIG. 1 is a block diagram of an apparatus 100 for estimating solar radiation energy resources, according to some embodiments of the present disclosure. As shown in FIG. 1, apparatus 100 includes an input/output (I/O) interface 120, a processor 140, and a memory 160. Processor 140 may be coupled to I/O interface 120 to input data, such as solar site metadata 111, satellite weather data 112, and measured solar data 113; or to output data, such as estimated solar resources 130. Processor 140 may also be coupled to memory 160 to access data for estimating solar radiation energy resources. These elements of apparatus 100 may be configured to transfer data and send or receive instructions and signals between or among each other.

I/O interface 120 may be coupled with processor 140 to provide input data, such as solar site metadata 111, satellite weather data 112, and measured solar data 113, from one or more external databases or from memory 160. In addition, I/O interface 120 may be coupled with processor 140 to receive output data, such as estimated solar resources 130, and send the output data to an external device or to memory 160.

Processor 140 may include one or more of: a central processing unit (CPU) with one or more processing cores, a graphics processing unit (GPU) with one or more processing cores, an application-specific integrated circuit (ASIC), a digital signal processor (DSP), a field-programmable gate array (FPGA), or another integrated circuit configured to perform instructions. Processor 140 can be configured by one or more programs stored in memory 160 to perform operations with respect to the methods and apparatus illustrated and described herein.

Memory 160 may be configured to store data (e.g., a set of instructions, computer codes, intermediate data, or the like). For example, as shown in FIG. 1, the stored data may include program instructions and data for processing. Processor 140 may access the program instructions and data for processing and execute the program instructions to perform an operation or manipulation on the data for processing. Memory 160 may include a high-speed random-access storage device or a non-volatile storage device. In some embodiments, memory 160 may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 160 may also be a group of memories (not shown in FIG. 1) grouped as a single logical component.

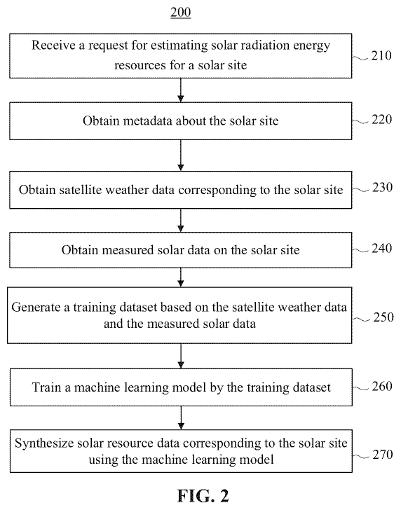

FIG. 2 is a flowchart of an exemplary method 200 for estimating solar radiation energy resources, according to some embodiments of the present disclosure. Method 200 may be performed by apparatus 100 for estimating solar radiation energy resources. Method 200 includes receiving a request for estimating solar radiation energy resources for a solar site (step 210), obtaining metadata about the solar site (step 220), obtaining satellite weather data corresponding to the solar site (step 230), obtaining measured solar data on the solar site (step 240), generating a training dataset based on the satellite weather data and the measured solar data (step 250), training a machine learning model by the training dataset (step 260), and synthesizing solar radiation energy resource data corresponding to the solar site using the machine learning model (step 270).

Step 210 includes receiving a request for estimating solar radiation energy resources for a solar site. For example, processor 140 of apparatus 100 may be configured to receive a request from a user interface or an external device to estimate solar radiation energy resources of a solar site. The request may include an identification, a name, and/or a geographic location of the solar site and/or information associated with the solar site. In some embodiments, the request may also include a requested period of time, such as a starting date and an ending date, during which solar data is requested.

Step 220 includes obtaining metadata about the solar site. For example, after apparatus 100 receives the request to estimate solar radiation energy resources of the solar site, processor 140 of apparatus 100 may be configured to access one or more databases based on the identification, name, and/or geographic location of the solar site, the information associated with the solar site, and/or the requested period of time to obtain the metadata about the solar site. The one or more databases may include at least one of a solar customer relationship management (CRM) database or a meteorological (MET) station database.

The metadata includes at least one of the latitude, longitude, and elevation values of the solar site; date information about a project of the solar site; equipment information about a meteorological station at the solar site; or solar radiation energy resource at the solar site. The equipment information may include sensor uncertainties and/or measure capability (e.g., GHI, POA irradiance, ambient temperature, wind speed, relative humidity, ground albedo).

In some embodiments, after obtaining the metadata of the solar site, processor 140 of apparatus 100 may be configured to generate solar irradiance estimate data of the solar site based on the metadata of the solar site. The metadata includes, for example, the latitude and longitude values of the solar site and the date information about a project of the solar site. The latitude and longitude values of the solar site provide a position of the solar site on the earth. The date information about the project includes, for example, the start and end dates of the project that a user may be interested in estimating how much solar insolation can be collected at the position. Processor 140 may be configured to estimate a solar irradiance value at the position of the solar site over the period between the start and end dates based on a solar positioning algorithm and decomposition of irradiance into relevant components.

For example, processor 140 may be configured to calculate a plurality of clear sky global horizontal irradiance (GHI) values based on a clear sky model and the date information. The clear sky model may include one or more of Bird, Simple Solis, McClear, Ineichen-Perez, Haurwitz, or Berger-Duffie clear sky models. The date information may indicate, for example, a start date and an end date. Processor 140 may be configured to calculate a time series of clear sky GHI values using the Ineichen-Perez clear sky model at the solar site's position over the period from the start date to the end date.

Processor 140 may be further configured to generate solar irradiance estimate data of the solar site based on the plurality of clear sky GHI values. For example, the calculated time series of clear sky GHI values may be a time series in minutes. Processor 140 may be configured to sum each hour's clear sky GHI values to generate a time series of clear sky GHI values in hours. As another example, processor 140 may be configured to sum each day's clear sky GHI values to generate a time series of clear sky GHI values in days.

Step 230 includes obtaining satellite weather data corresponding to the solar site. For example, processor 140 of apparatus 100 may be configured to access satellite weather data corresponding to the solar site's position from a satellite weather database on a cloud server. Specifically, processor 140 may be configured to send a request message to the cloud server. The request message may include, for example, the position of the solar site and the date information. Processor 140 may be further configured to receive the satellite weather data from the satellite weather database on the cloud server.

Additionally or alternatively, in some embodiments, an application programming interface (API) of satellite weather data may be available to apparatus 100 for estimating solar radiation energy resources. The API of satellite weather data may provide access to the satellite weather data on a server or a database. Processor 140 of apparatus 100 may be configured to request the satellite weather data at the solar site's position over the period indicated by the date information. Processor 140 may be further configured to receive the satellite weather data from the API of satellite weather data.

Additionally or alternatively, in some embodiments, the satellite weather data corresponding to the solar site may have been saved in a storage device, such as memory 160 (FIG. 1) or a remote storage (e.g., a cloud-based storage). Processor 140 of apparatus 100 may be configured to access and receive the satellite weather data from the storage device.

The satellite weather data corresponding to the solar site includes, for example, one or more time series of global horizontal irradiance (GHI) (W/m²), direct normal irradiance (DNI) (W/m²), ambient temperatures (degree C.), wind speeds (m/s), relative humidity (%), liquid precipitation (kg/m²), solid precipitation (kg/m²), snow depth (m), clear sky GHI, clear sky DNI, clear sky diffuse horizontal irradiance (DHI), irradiance observation type, data version, observation time (GMT), diffuse horizontal irradiance (DIF) (W/m²), ambient temperature observation type, wind speed observation type, Albedo, particulate matter 10 (μg/m³), and/or particulate matter 2.5 (μg/m³).

Step 240 includes obtaining measured solar data on the solar site. For example, one or more meteorological (MET) stations may be installed on the solar site or in proximity to the solar site. The MET stations include different sensors that measure various weather parameters, such as solar radiation, wind speed, wind direction, temperature, relative humidity, and ground albedo. Processor 140 of apparatus 100 may be configured to receive measured solar data on the solar site from one or more of the sensors of the MET stations.

Additionally or alternatively, in some embodiments, an application programming interface (API) of measured solar data may be available to apparatus 100 for obtaining measured solar data on the solar site. The API of measured solar data provides access to the measured solar data on a server or a database. Processor 140 of apparatus 100 may be configured to request the measured solar data through the API of measured solar data. Processor 140 may be further configured to receive the measured solar data from the API of satellite weather data.

Additionally or alternatively, in some embodiments, the measured solar data corresponding to the solar site may have been saved in a storage device, such as memory 160 (FIG. 1) or a cloud storage. Processor 140 of apparatus 100 may be configured to access and receive the measured solar data from the storage device.

The measured solar data on the solar site includes, for example, one or more of time series of average GHI (W/m²), average GHI with clean photovoltaic (PV) surface (W/m²), average GHI with soiled PV surface (W/m²), average short-circuit current with clean PV surface (Amps), average short-circuit current with soiled PV surface (Amps), average module temperature with clean PV surface (degree C.), average module temperature with soiled PV surface (degree C.), average ambient temperature (degree C.), mean wind speed (m/s), mean wind direction (degree), maximum wind speed (m/s), average relative humidity (%), average barometric pressure (mar), instantaneous rain (mm), and/or solar elevation angle (degree).

Step 250 includes generating a training dataset based on the satellite weather data and the measured solar data. For example, processor 140 of apparatus 100 may be configured to generate a training dataset based on the satellite weather data and the measured solar data of the solar site. Specifically, processor 140 may be configured to extract the time series of clear sky GHI and arrange them as the training dataset's clear sky irradiance component. Processor 140 may be further configured to extract the time series of GHI, ambient temperatures, wind speed, and relative humidity from the satellite weather data in step 230 and arrange them as the training dataset's satellite irradiance components and satellite ambient temperatures, respectively. In addition, processor 140 may be further configured to extract the time series of measured GHI, ambient temperatures, wind speed, and relative humidity from the measured solar data in step 240 and arrange them as the training dataset's measured irradiance components, measured ambient temperatures, measured wind speed, and measured relative humidity, respectively. Accordingly, the training dataset includes the clear sky irradiance components, satellite irradiance components, measured irradiance components, satellite ambient temperatures, measured ambient temperatures, satellite wind speed, measured wind speed, satellite relative humidity, and measured relative humidity.

In some embodiments, the training dataset may further include the metadata of the solar site, such as the latitude, longitude, and elevation values of the solar site; date information about a project of the solar site; equipment information about a meteorological station at the solar site; and/or solar radiation energy resource at the solar site.

Step 260 includes training a machine learning model with the training dataset. For example, processor 140 of apparatus 100 may be configured to train a machine learning model that runs on apparatus 100, by the training dataset. Processor 140 may be configured to train at least one of a supervised learning model, a neural network model, or an ensemble of models by the training dataset. In some embodiments, processor 140 may be configured to train at least one of a multivariate regression model, a support vector machine regression model, a gradient boosting ensemble model, or an artificial neural network model by the training dataset.

Step 270 includes synthesizing solar radiation energy resource data corresponding to the solar site using the machine learning model. For example, after training the machine learning model, processor 140 of apparatus 100 may be configured to synthesize solar radiation energy resource data corresponding to the solar site using the machine learning model. Specifically, processor 140 may be configured to synthesize, for example, a long-term historical time series data file or a typical meteorological year (TMY) file of the solar site using the machine learning model. The long-term historical time series data file or TMY file includes, for example, one or more time series of estimated irradiance, ambient temperature, wind speed, and relative humidity values for every hour in, for example, a calendar year for the solar site's position in the past or in the future. In some embodiments, the period of the time series may span any period of time, such as a day, a week, a month, a few months, a year, or multiple years with flexible starting and ending times. Processor 140 may be configured to synthesize a time series data file for the period of time. Such solar radiation energy resource data (or estimated irradiance values) may be sensor-informed or calibrated solar radiation energy resource data, which decreases the uncertainty in the available solar radiation energy resources of the solar site. In some embodiments, the solar radiation energy resource data includes calibrated satellite weather data.

In some embodiments, in addition to the training dataset, processor 140 of apparatus 100 may also be configured to generate a test dataset based on the satellite weather data and the measured solar data. The test dataset includes clear sky irradiance components, satellite irradiance components, measured irradiance components, satellite ambient temperatures, measured ambient temperatures, satellite wind speed, measured wind speed, satellite relative humidity, and measured relative humidity similar to the training dataset. The test dataset does not overlap the training dataset and may not be used to train the machine learning model. Instead, processor 140 may be configured to evaluate the machine learning model by the test dataset.

For example, processor 140 may be configured to select a time period (e.g., a specific day, week, or month) and obtain satellite irradiance components, measured irradiance components, satellite ambient temperatures, measured ambient temperatures, satellite wind speed, measured wind speed, satellite relative humidity, and measured relative humidity over the selected time period, similar to operations described above in steps 230 and 240. Processor 140 may also be configured to form a test dataset based on these data over the selected time period and not include these data into any training dataset in step 250. In addition, processor 140 may be configured to synthesize solar resource data over the selected time period using a trained machine learning model to obtain a test solar resource data. The test solar resource data may include synthesized irradiance components, synthesized ambient temperatures, synthesized wind speeds, and synthesized relative humidities over the selected time period. Processor 140 may be configured to compare the test solar resource data over the selected time period with the measured solar resource data over the selected time period. The measured solar resource data may include the measured irradiance components, measured ambient temperatures, measured wind speed, and measured relative humidities over the selected time period. Processor 140 may be configured to evaluate the trained machine learning model by adding up differences between the test solar resource data and the measured solar resource data as an accuracy index for the trained machine learning model.

In some embodiments, processor 140 may be configured to evaluate a plurality of machine learning models by the procedure as described above to obtain their accuracy indexes. The plurality of machine learning models may include a supervised learning model, a neural network model, an ensemble of model, a multivariate regression model, a support vector machine regression model, a gradient boosting ensemble model, an artificial neural network model, and/or any machine learning model. Processor 140 may also be configured to compare the accuracy indexes to select one of the machine learning models as a suitable machine learning mode for a solar site.

Additionally or alternatively, in some embodiments, processor 140 may be configured to train a machine learning model using a plurality of training datasets. Processor 140 may also be configured to obtain a plurality of accuracy indexes of the machine learning model trained by the plurality of training datasets. Processor 140 may also be configured to compare the accuracy indexes to select the machine learning model trained by one of the plurality of training datasets as a suitable machine learning mode for the solar site.

In some embodiments, the training dataset and the test dataset may have X % and Y % of a whole dataset corresponding to the solar site. Processor 140 may be configured to split the whole dataset into the training and test datasets with different percentages and evaluate which train-test split options (i.e., different percentages or X and Y values) result in the machine learning model with the best performance (e.g., the lowest estimation uncertainty of the solar radiation energy resources).

In some embodiments, the training dataset in step 250 may be a first training dataset over a first period of time. After a second period of time, processor 140 of apparatus 100 may be configured to obtain additional measured solar data from the sensors of the MET stations on the solar site. Processor 140 may be further configured to generate a second training dataset based on the satellite weather data and the measured solar data over the second period of time. The second training dataset includes clear sky irradiance components, satellite irradiance components, measured irradiance components, satellite ambient temperatures, measured ambient temperatures, satellite wind speed, measured wind speed, satellite relative humidity, and measured relative humidity. Processor 140 may be configured to further train the machine learning model by the second training dataset. The further trained machine learning model may be expected to provide solar radiation energy resource estimation data with less uncertainty.

In some embodiments, the training dataset in step 250 may be a first training dataset over a first period of time, and the solar radiation energy resource data in step 270 may be first solar radiation energy resource data. Processor 140 of apparatus 100 may be configured to obtain additional measured solar data from the sensors of the MET stations on the solar site over a second period of time. The second period of time may be later than the first period of time. Processor 140 may be further configured to generate a plurality of second training datasets based on the satellite weather data and the measured solar data over the second period of time. The plurality of second training datasets corresponds to time series that are later than the time series of the first training dataset. The plurality of second training datasets includes clear sky irradiance components, satellite irradiance components, measured irradiance components, satellite ambient temperatures, measured ambient temperatures, satellite wind speed, measured wind speed, satellite relative humidity, and measured relative humidity. Processor 140 may be configured to train the machine learning model by using the plurality of second training datasets. In some embodiments, the second period of time may be a day, a week, a month, several months, or any other period of time.

In some embodiments, after training the machine learning model by using the plurality of second training datasets, processor 140 may be further configured to synthesize second solar radiation energy resource data corresponding to the solar site using the machine learning model. For example, processor 140 may be configured to synthesize a TMY file of the solar site using the machine learning model. The TMY file includes, for example, one or more time series of estimated irradiance values for every hour in a calendar year for the solar site's position. Such solar radiation energy resource data (or estimated irradiance values) may be sensor-informed and/or calibrated solar radiation energy resource data, which may be expected to provide less uncertainty to the available solar radiation energy resources of the solar site than those solar radiation energy resource data synthesized by a previously trained machine learning model. In some embodiments, the second solar radiation energy resource data includes calibrated satellite weather data.

In some embodiments, apparatus 100 may be a cloud-based machine learning operations (MLOps) system that continuously retrains the machine training model once newly measured solar data as well as satellite weather data at a same period of time. For example, processor 140 of apparatus 100 may be configured to continuously retrain the machine training model every month and configured to generate solar radiation energy resource data for any period of time in the future or in the past using the continuously retrained machine training model.

In some embodiments, one or more of the sensors of the MET station on the solar site may be inoperative (e.g., broken or unable to communicate its measurements). This may result in missing or erroneous measured solar data of the solar site. Processor 140 of apparatus 100 may be configured to generate estimated to-be-measured solar data that is supposed to be measured by one or more broken sensors of the MET station using the machine learning model. Processor 140 may be configured to backfill missing or erroneous measured solar data during the sensor downtime in the database by the estimated to-be-measured solar data. This may reduce the impact of unforeseen sensor downtime of the MET station during periodic performance evaluation.

In some embodiments, processor 140 of apparatus 100 may be configured to determine a time to charge or discharge a co-located energy storage system based on the solar radiation energy resource data and the satellite weather data corresponding to the solar site. For example, processor 140 may be configured to generate solar radiation energy resource data corresponding to the solar site over a week using the machine learning model. If the solar radiation energy resource data indicates that the second day of the week has less solar energy to collect because of bad weather, processor 140 may be configured to send a control signal to control the solar site to charge a co-located energy storage system on the first day of the week.

The solar site may include a solar site control server. The solar site control server may be implemented by, for example, a computing server. The solar site control server may be configured to set the charge and/or discharge setpoints of the co-located energy storage system based on desired and/or expected output energies from the solar site. The solar site control server may be configured to receive an estimate of solar radiation energy resources from apparatus 100 for the next few hours or next few days. The solar site control server may be configured to run an optimization engine to determine optimal charge and discharge setpoints such that the desired output energies from the solar site may be achieved or deviations of the output energies from the desired output energies may be minimized.

As another example, if the solar radiation energy resource data indicates that the next whole week has sufficient solar energy to collect, processor 140 may be configured to control the co-located energy storage system to dispatch its power to energy storage at a different place because the co-located energy storage system can be charged over the whole week. The solar site control server may be configured to receive an estimate of solar radiation energy resources from apparatus 100 indicating the sufficient solar energy to be collected in the next whole week. The solar site control server may be configured to dispatch energy stored in the co-located energy storage system to a different storage system that requires the energy at the time.

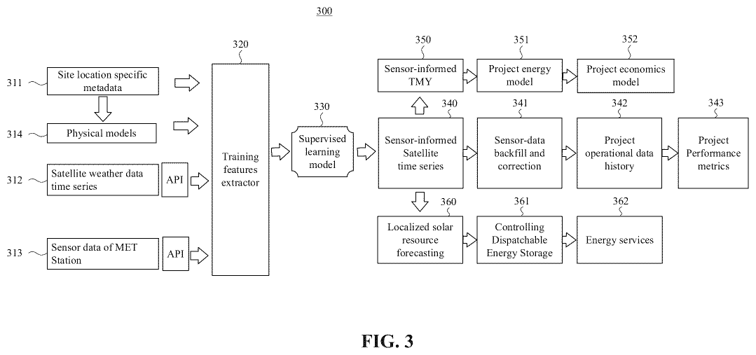

FIG. 3 is a diagram of an exemplary data flow 300 for estimating solar radiation energy resources, according to some embodiments of the present disclosure. As shown in FIG. 3, data flow 300 includes inputting site location-specific metadata 311, satellite weather data time series 312, and sensor data of MET station 313 to a training features extractor 320. Site location specific metadata 311, satellite weather data time series 312, and sensor data of MET station 313 correspond to solar site metadata 111 (FIG. 1), satellite weather data 112 (FIG. 1), and measured solar data 113 (FIG. 1), respectively. Processor 140 of apparatus 100 can be configured to input site location-specific metadata 311, satellite weather data time series 312, and sensor data of MET station 313 to training features extractor 320 by performing operations of steps 220, 230, and 240, as described above for method 200 with reference to FIG. 2.

Data flow 300 also includes inputting site location-specific metadata 311 to physical models 314 to generate, for example, time series of clear sky irradiance and ambient temperature and inputting them to training features extractor 320. Processor 140 of apparatus 100 can be configured to generate the time series of clear sky irradiance and ambient temperature based on site location-specific metadata 311.

Data flow 300 also includes generating a training dataset for training a supervised learning model 330. Processor 140 of apparatus 100 can be configured to generate the training dataset for training supervised learning model 330 by performing step 250, as described above for method 200 with reference to FIG. 2.

Data flow 300 also includes training supervised learning model 330 by the training dataset from training features extractor 320. Processor 140 of apparatus 100 can be configured to train supervised learning model 330 by the training dataset by performing step 260, as described above for method 200 with reference to FIG. 2.

Data flow 300 also includes generating sensor-informed satellite time series 340. Processor 140 of apparatus 100 can be configured to generate sensor-informed satellite time series 340 by performing step 270, as described above for method 200 with reference to FIG. 2.

By using sensor-informed satellite time series 340, data flow 300 also includes sensor-data backfill and correction 341. Processor 140 of apparatus 100 may be configured to perform sensor-data backfill and correction 341 when a sensor is down, as described above for method 200 with reference to FIG. 2.

Data flow 300 also includes managing project operational data history 342 and project performance metrics 343. Project operational data history 342 may include measured power output from one or more inverters in the solar site. Project performance metrics 343 may include performance indexes of the inverters in the solar site. The performance indexes may be ratios of measured solar energy from a photovoltaic system to the predicted energy using a photovoltaic performance mode. Processor 140 of apparatus 100 may be configured to maintain project operational data 342 by sensor-informed satellite time series 340. Processor 140 of apparatus 100 may be configured to calculate project performance metrics 343 by sensor-informed satellite time series 340.

As shown in FIG. 3, data flow 300 also includes generating sensor-informed TMY 350 by using sensor-informed satellite time series 340. Processor 140 of apparatus 100 may be configured to generate sensor-informed TMY 350 by using sensor-informed satellite time series 340, as described above for method 200 with reference to FIG. 2.

Data flow 300 also includes generating project energy model 351 and project economics model 352. Project energy model 351 may include one or more energy models estimating solar radiation energies that may be gathered by one or more photovoltaic systems in a project. Project economics model 352 may include an econometric model based on solar energy production data, capital expenditure, and/or operational expenditure. In some embodiments, project economics model 352 may also include tax liabilities and credits, market prices, and/or equipment cost curves, to accurately calculate project development returns. Processor 140 of apparatus 100 may be configured to generate project energy model 351 based on sensor-informed TMY 350 over a period of a project. Processor 140 of apparatus 100 may be further configured to build project economics model 352 based on sensor-informed TMY 350 and project energy model 351.

As shown in FIG. 3, data flow 300 also includes localized solar radiation energy resource forecasting 360. Processor 140 of apparatus 100 may be configured to forecast localized solar radiation energy resources corresponding to a solar site's position by using sensor-informed satellite time series 340, as described above for method 200 with reference to FIG. 2.

Data flow 300 also includes controlling dispatchable energy storage 361 and providing energy services 362. Processor 140 of apparatus 100 may be configured to control dispatchable energy storage 361 based on forecasted localized solar radiation energy resources 360, as described above for method 200 with reference to FIG. 2. Processor 140 may be configured to provide energy services 362 by dispatching energy from a co-located energy storage system, as described above for method 200 with reference to FIG. 2.

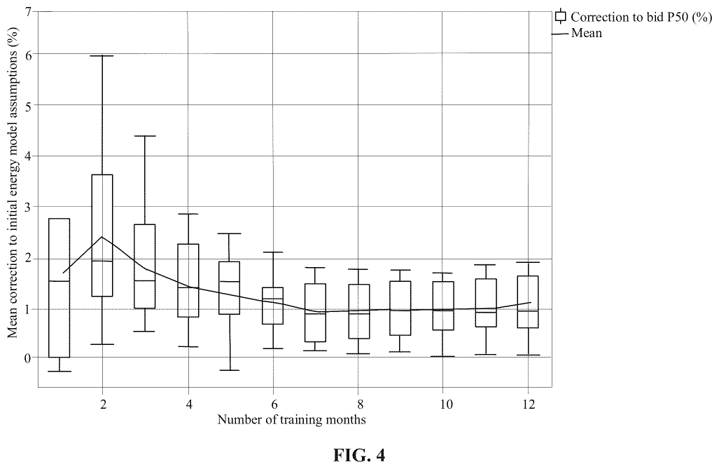

FIG. 4 illustrates the results of an exemplary method for estimating solar radiation energy resources, according to some embodiments of the present disclosure. As shown in FIG. 4, when a number of training months increases, mean correction percentages from estimated solar radiation energy resources reduce from more than 2% to about 1%. That is, when processor 140 of apparatus 100 continues to retrain the machine learning model using new training data, processor 140 may be able to estimate solar radiation energy resources more accurately.

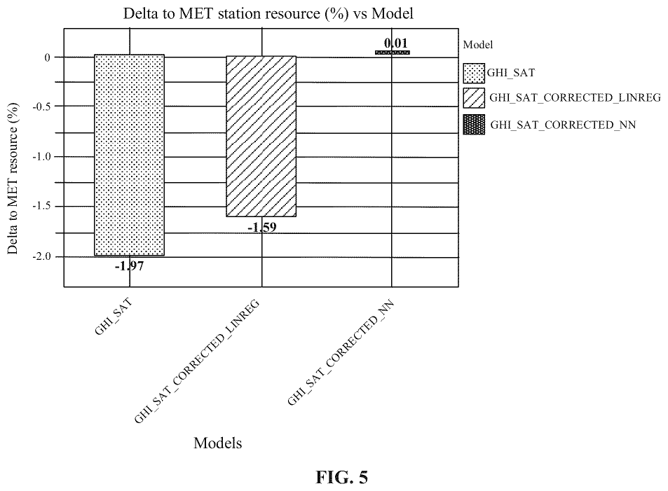

FIG. 5 illustrates the results of three exemplary methods for estimating solar radiation energy resources, according to some embodiments of the present disclosure. In FIG. 5, GHI_SAT model applies untuned satellite data, received directly from a data vendor, to estimate solar radiation energy resources. GHI_SAT_CORRECTED_LINREG model uses an ordinary least squares regression model to estimate solar radiation energy resources. GHI_SAT_CORRECTED_NN model includes a multi-layer neural network to estimate solar radiation energy resources. FIG. 5 illustrates that the estimated solar radiation energy resources by the GHI_SAT model have a 1.97% difference from the measured solar data at the MET station. The estimated solar radiation energy resources by the GHI_SAT model has a 1.59% difference from the measured solar data at the MET station. The estimated solar radiation energy resources by the GHI_SAT_CORRECTED_NN model have a 0.01% difference from the measured solar data at the MET station. That is, the neural network model described herein improves the accuracy of the satellite model from approximately 2% of the default satellite model to 0.01%.

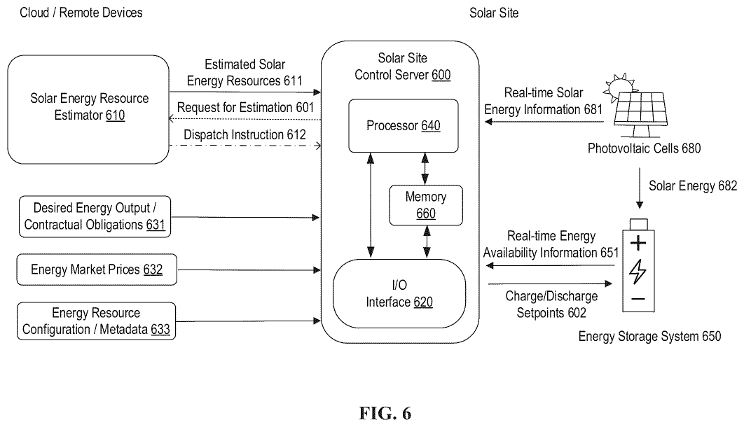

FIG. 6 illustrates an exemplary solar site control server 600, according to some embodiments of the present disclosure. As shown in FIG. 6, solar site control server 600 may communicate with a solar energy resource estimator 610, photovoltaic cells 680, and/or an energy storage system 650. Solar site control server 600 may be configured to receive information including desired energy output and/or contractual obligations 631, energy market prices 632, and/or energy resource configuration and/or metadata 633.

Solar site control server 600 may include an input/output (I/O) interface 620, a processor 640, and a memory 660. These elements of solar site control server 600 may be configured to transfer data and send or receive instructions and signals between or among each other. I/O interface 620, processor 640, and memory 660 may be components or devices similar to I/O interface 120, processor 140, and memory 160, respectively, as described above with reference to FIG. 1. Processor 640 may be configured to execute instructions stored in memory 660 to receive and/or transmit data as described herein with reference to solar site control server 600 in FIG. 6. Processor 640 may also be configured to execute instructions stored in memory 660 to perform operations as described herein with reference to solar site control server 600 in FIG. 6.

Solar energy resource estimator 610 may include apparatus 100 (FIG. 1) for estimating solar radiation energy resources at the solar site, as described with reference to FIGS. 1-5. For example, solar energy resource estimator 610 may be configured to receive a request for estimation 601 for solar radiation energy resources in the next three days at the solar site from solar site control server 600 or from a user interface (not shown) connected to I/O interface 120 (FIG. 1). Solar energy resource estimator 610 may also be configured to obtain metadata about the solar site, such as an identification of the solar site, a name of the site, and/or geographic location of photovoltaic cells 680 of the solar site. In addition, solar energy resource estimator 610 may be configured to obtain satellite weather data corresponding to the solar site from one or more satellite weather databases.

In some embodiments in which a machine learning model for estimating solar radiation energy resources may not be trained yet or retrained by the latest measured solar data, solar energy resource estimator 610 may be configured to obtain up-to-date measured solar data from solar site control server 600. Solar site control server 600 may be configured to obtain the up-to-date measured solar data from photovoltaic cells 680. Solar energy resource estimator 610 may also be configured to generate a training dataset based on the satellite weather data and the measured solar data of photovoltaic cells 680. Solar energy resource estimator 610 may also be configured to train the machine learning model using the training dataset. After the training, solar energy resource estimator 610 may be configured to synthesize solar radiation energy resource data for the next three days, for example, using the trained machine learning model. Solar energy resource estimator 610 may be configured to send the synthesized solar radiation energy resource data as estimated solar energy resources 611 for the next three days to solar site control server 600.

Alternatively, in some embodiments in which the machine learning model for estimating solar radiation energy resources may have been trained by the latest measured solar data, solar energy resource estimator 610 may be configured to synthesize solar radiation energy resource data for the next three days, for example, using the trained machine learning model. Solar energy resource estimator 610 may also be configured to send the synthesized solar radiation energy resource data as estimated solar energy resources 611 for the next three days to solar site control server 600.

Solar energy resource estimator 610 may be configured to receive estimated solar energy resources 611 from solar energy resource estimator 610 and recognize estimated solar energy resources 611 as to-be-collected solar energy for the next three days at photovoltaic cells 680. Solar site control server 600 may be configured to run a mixed integer non-linear optimization engine to determine how to dispatch energy stored in energy storage system 650 and the to-be-collected solar energy from photovoltaic cells 680. For example, at the time, solar site control server 600 may be configured to reserve the energy stored in energy storage system 650 for supplying to a first factory the following week. Because solar site control server 600 may have information about the to-be-collected solar energy of photovoltaic cells 680 in the next three days, solar site control server 600 may be configured to dispatch an equal amount of the to-be-collected solar energy of photovoltaic cells 680 from energy storage system 650 first to supply a second factory. That is, solar site control server 600 may be configured to run the mixed integer non-linear optimization engine to determine to dispatch the equal amount of the to-be-collected solar energy of photovoltaic cells 680 for supplying the second factory before photovoltaic cells 680 collect that amount of solar energy in the next three days.

This may help meet the second factory's urgent need. Moreover, estimated solar energy resources 611 provided by solar energy resource estimator 610 may be accurate with only a 0.01% difference from the collected solar energy by photovoltaic cells 680 in the next three days, as described above with reference to FIG. 5. The accurate estimation of the solar energy resources by solar energy resource estimator 610 may enable solar site control server 600 to manage energy dispatches with flexibility to meet different needs of energy.

In some embodiments, solar site control server 600 may be configured to receive desired energy output/contractual obligations 631, energy market prices 632, and/or energy resource configuration/metadata 633 from one or more remote devices. Desired energy output/contractual obligations 631 may include information about a desired energy output volume from the solar site and/or an energy amount specified in an energy contract as an obligation to supply. Energy market prices 632 may include information about energy market prices at the current time and/or in the future. Energy resource configuration/metadata 633 may include information about usage arrangements of stored energy in energy storage system 650 and/or updated sensor data of photovoltaic cells 680. Solar site control server 600 may be configured to run the mixed integer non-linear optimization engine based on the information in desired energy output/contractual obligations 631, energy market prices 632, and/or energy resource configuration/metadata 633, to determine how to dispatch energy stored in energy storage system 650 and the to-be-collected solar energy from photovoltaic cells 680.

Photovoltaic cells 680 may include a plurality of photovoltaic cells and sensors configured to collect solar energy 682 and measure temperature, humidity, sun, and/or wind indexes at the solar site. As shown in FIG. 6, photovoltaic cells 680 may be configured to store collected solar energy 682 in energy storage system 650. In some embodiments, photovoltaic cells 680 may also be configured to provide real-time solar energy information 681 to solar site control server 600, as shown in FIG. 6. Real-time solar energy information 681 may include a volume of collected solar energy 682, measured temperature index, measured humidity index, sun index, and/or wind index. In some embodiments, solar site control server 600 may be configured to run the mixed integer non-linear optimization engine based on real-time solar energy information 681 to determine how to dispatch energy stored in energy storage system 650 and the to-be-collected solar energy from photovoltaic cells 680.

Energy storage system 650 may include a plurality of energy storage devices, such as batteries. As shown in FIG. 6, energy storage system 650 may be configured to store solar energy collected by photovoltaic cells 680. Energy storage system 650 may also be configured to provide real-time energy availability information 651 to solar site control site server 600 so that solar site control site server 600 has real-time energy availability information 651 to determine how to dispatch energy stored in energy storage system 650. In some embodiments, solar site control server 600 may be configured to run the mixed integer non-linear optimization engine based on real-time energy availability information 651 from energy storage system 650 and real-time solar energy information 681 from photovoltaic cells 680 to determine how to dispatch energy stored in energy storage system 650 and the to-be-collected solar energy from photovoltaic cells 680. For example, solar site control server 600 may be configured to determine charge/discharge setpoints 602 and send charge/discharge setpoints 602 to energy storage system 650 to control charge and/or discharge operations.

In some embodiments, solar site control server 600 may be configured to run the mixed integer non-linear optimization engine to determine charge/discharge setpoints 602 based on at least one of estimated solar energy resources 611 from solar energy resource estimator 610, desired energy output/contractual obligations 631, energy market prices 632, energy resource configuration/metadata 633, real-time solar energy information 681 from photovoltaic cells 680, or real-time energy availability information 651 from energy storage system 650. Solar site control server 600 may be also configured to send charge/discharge setpoints 602 to energy storage system 650 to control charge and/or discharge operations.

In some embodiments, solar energy resource estimator 610 may be configured to send estimated solar energy resources 611 and a dispatch instruction 612 to solar site control server 600. Solar site control server 600 may be configured to receive the information about estimated solar energy resources 611 and execute dispatch instruction 612 based on estimated solar energy resources. For example, solar site control server 600 may be configured to run the mixed integer non-linear optimization engine to determine charge/discharge setpoints 602 based on estimated solar energy resources 611 and dispatch energy stored in energy storage system 650 and/or to-be-collected energy from photovoltaic cells 680 in accordance with dispatch instruction 612 from solar energy resource estimator 610.

The methods and apparatus herein calibrate historical and real-time satellite time series data based on measurements of ground sensors of the MET station. The methods and apparatus can maintain an energy model on record that is continuously calibrated as more ground data from the sensors of the MET station is available. The methods and apparatus can synthesize a TMY file calibrated to a site-specific location. The methods and apparatus can reduce the gap between satellite weather data and available solar radiation energy resources on a solar site. The methods and apparatus can also reduce the influence of choice between satellite data vendors on project economics by producing a sensor-informed TMY file. The methods and apparatus also enable the use of sensor-informed satellite solar radiation energy resources to improve the accuracy of solar radiation energy resource forecasting. Dispatch controllers of dispatchable renewable energy require the accuracy of solar radiation energy resource forecasting. In addition, the methods and apparatus maintain a continuously trained site-specific sensor-informed solar radiation energy resource model that can backfill missing or erroneous sensor data to reduce the impact of unforeseen sensor downtime during periodic performance evaluation. The methods and apparatus can reduce renewable project portfolio underperformance payout risks. The methods and apparatus include or perform continuous learning methods that act as a hedge against potential uncertainty due to changing climate patterns. The energy models may be continuously updated by ground measurements and do not rely on pre-built resource assumptions.

The methods and apparatus include an automated process that reduces personnel load and reduces user error. The methods and apparatus can generate periodic reports for project due diligence and financing. Based on supervised learning models, the methods and apparatus improve accuracy of the estimated solar radiation energy resources. The methods and apparatus provide a scalable process that enables the use of any arbitrary project portfolio sizes. The methods and apparatus include operational optimization that quantifies performance prediction and reduces operation risks.

In this disclosure, the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media may include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments may be implemented as devices or modules using hardware circuits, software, or combinations thereof. For example, a hardware circuit implementation may include discrete analog or digital components that are, for example, integrated as part of a printed circuit board. Alternatively, or additionally, the disclosed components or modules may be implemented as an Application Specific Integrated Circuit (ASIC) or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C.

What is claimed is:

1. A non-transitory computer-readable medium storing instructions that are executable by one or more processors of a device to perform operations for estimating solar radiation energy resources, the operations comprising:
obtaining metadata about a solar site;
obtaining satellite weather data corresponding to the solar site;
obtaining measured solar data on the solar site;
generating a training dataset based on the satellite weather data and the measured solar data;
training a machine learning model by the training dataset; and
synthesizing solar radiation energy resource data corresponding to the solar site using the machine learning model.

2. The non-transitory computer-readable medium of claim 1, wherein the training dataset is a first training dataset and the solar radiation energy resource data are first solar radiation energy resource data, the operations further comprising:
generating a plurality of second training datasets, the plurality of second training datasets corresponding to time series that are later in time than a time series of the first training dataset;
training the machine learning model by using the plurality of second training datasets; and
synthesizing second solar radiation energy resource data corresponding to the solar site using the machine learning model, the second solar radiation energy resource data including calibrated satellite weather data.

3. The non-transitory computer-readable medium of claim 1, wherein obtaining the metadata about the solar site comprises receiving the metadata from at least one of
a customer relationship management database, or
a meteorological station database.

4. The non-transitory computer-readable medium of claim 1, wherein the metadata comprises at least one of:
latitude, longitude, and elevation values of the solar site,
date information about a project of the solar site,
equipment information about a meteorological station at the solar site, or
solar radiation energy resources at the solar site.

5. The non-transitory computer-readable medium of claim 1, wherein obtaining the satellite weather data corresponding to the solar site comprises:
receiving the satellite weather data from at least one of
a satellite weather database,
an application programming interface of satellite weather data, or
a storage device.

6. The non-transitory computer-readable medium of claim 1, wherein the satellite weather data comprises:
a time series of global horizontal irradiance (GHI) values corresponding to the solar site; and
a time series of ambient temperature values corresponding to the solar site.

7. The non-transitory computer-readable medium of claim 1, wherein obtaining the measured solar data on the solar site comprises:
receiving the measured solar data from at least one of
a sensor on the solar site,
a meteorological station on the solar site,
an application programming interface of the measured solar data, or
a storage device.

8. The non-transitory computer-readable medium of claim 1, wherein the training dataset comprises a plurality of time series of:
satellite irradiance components,
measured irradiance components,
satellite ambient temperatures, and
measured ambient temperatures.

9. The non-transitory computer-readable medium of claim 8, wherein the training dataset further comprises a plurality of time series of:
satellite wind speeds,
measured wind speeds,
satellite relative humidities, and
measured relative humidities.

10. The non-transitory computer-readable medium of claim 1, wherein the machine learning model comprises at least one of:
a supervised learning model,
a neural network model, or
an ensemble of models.

11. The non-transitory computer-readable medium of claim 1, wherein synthesizing the solar radiation energy resource data corresponding to the solar site using the machine learning model comprises:
synthesizing a typical meteorological year file of the solar site using the machine learning model.

12. The non-transitory computer-readable medium of claim 1, wherein synthesizing the solar radiation energy resource data corresponding to the solar site using the machine learning model comprises:
synthesizing a historical time series data file of the solar site using the machine learning model.

13. The non-transitory computer-readable medium of claim 1, wherein the satellite weather data and the measured solar data of the training dataset are over a first time series, the operations further comprising:
generating a test dataset based on satellite weather data and measured solar data over a second time series, the second time series not overlapping in time with the first time series;
synthesizing, by the trained machine learning model, test solar radiation energy resource data based on the satellite weather data over the second time series; and
determining an accuracy index of the trained machine learning model based on the test dataset and the test solar radiation energy resource data.

14. The non-transitory computer-readable medium of claim 1, wherein the training dataset is a first training dataset, the operations further comprising:
generating a second training dataset based on the satellite weather data and the measured solar data; and
training the machine learning model by the second training dataset.

15. The non-transitory computer-readable medium of claim 1, the operations further comprising:
generating to-be-measured solar data of a sensor on the solar site using the machine learning model, wherein the sensor is down during a period; and
backfilling solar data of the sensor during the period by the to-be-measured solar data.

16. The non-transitory computer-readable medium of claim 1, the operations further comprising:
controlling charging or discharging of a co-located energy storage system at a time determined by the trained machine learning model based on the solar radiation energy resource data and the satellite weather data corresponding to the solar site.

17. An apparatus for estimating solar radiation energy resources, the apparatus comprising:
a memory storing instructions;
at least one processor configured to execute the instructions to cause the apparatus to:
obtain metadata about a solar site;
obtain satellite weather data corresponding to the solar site;
obtain measured solar data on the solar site;
generate a training dataset based on the satellite weather data and the measured solar data;
train a machine learning model by the training dataset; and
synthesize solar radiation energy resource data corresponding to the solar site using the machine learning model.

18. The apparatus of claim 17, wherein the training dataset is a first training dataset, the solar radiation energy resource data are first solar radiation energy resource data, and the at least one processor is further configured to execute the instructions to cause the apparatus to:
generating a plurality of second training datasets, the plurality of second training datasets corresponding to time series that are later in time than time series of the first training dataset;
training the machine learning model by using the plurality of second training datasets; and
synthesizing second solar radiation energy resource data corresponding to the solar site using the machine learning model, the second solar radiation energy resource data including calibrated satellite weather data.

19. A method for estimating solar radiation energy resources, the method comprising:
obtaining metadata about a solar site;
obtaining satellite weather data corresponding to the solar site;
obtaining measured solar data on the solar site;
generating a training dataset based on the satellite weather data and the measured solar data;
training a machine learning model by the training dataset;
synthesizing solar radiation energy resource data corresponding to the solar site using the machine learning model; and
controlling charging or discharging of a co-located energy storage system at a time determined by the trained machine learning model based on the solar radiation energy resource data and the satellite weather data corresponding to the solar site.

20. The method of claim 19, wherein the training dataset is a first training dataset and the solar radiation energy resource data are first solar radiation energy resource data, the method further comprising:
generating a plurality of second training datasets, the plurality of second training datasets corresponding to time series that are later in time than time series of the first training dataset;
training the machine learning model by using the plurality of second training datasets; and
synthesizing second solar radiation energy resource data corresponding to the solar site using the machine learning model, the second solar radiation energy resource data including calibrated satellite weather data.
